(19) United States
(12) Patent Application Publication
(10) Pub. No.: US 2009/0240942 A1
(43) Pub. Date: Sep. 24, 2009

(54) LONG TERM KEY ESTABLISHMENT FOR EMBEDDED DEVICES

(75) Inventors: Ramon Rubio, Downey, CA (US); Joseph Yang, Cypress, CA (US); Royce E. Slick, Mission Viejo, CA (US)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/052,592

(22) Filed: Mar. 20, 2008

(51) Int. Cl. H04L 9/00

(52) U.S. Cl. 713/171

(57) ABSTRACT

A secure communication session is established between a first device and a second device, by generating, in the first device, a first secret key to be utilized for communication sessions with other devices. The second device requests to establish a first communication session with the first device, and the second device generates a second secret key corresponding to the first secret key of the first device. The second device stores the generated second secret key in a non-volatile memory of the second device, the second secret key being stored in the non-volatile memory in association with an identifier of the first device. Finally, a secure communication session is established between the first and second devices utilizing the first and second secret keys.

### BACKGROUND OF THE INVENTION

1. Field of the Invention

This present invention relates to the long term establishment of keys utilized for communication sessions between devices over a network. More particularly, the invention relates to one device generating a secret key for establishing a secure communication session with another device, and then storing the generated secret key in a non-volatile memory for establishing future communication sessions with the same device.

2. Related Background Art

In the field of secure network communications between devices, such as a printer and a personal computer, a secure key is utilized to establishing a secure communication session between the devices. One known technique for establishing a secure communication session between devices is known as the Diffie-Hellman method. Diffie-Hellman is a key establishment protocol that allows two entities to exchange secrets over an insecure connection without prior knowledge of the two. In Diffie-Hellman, one of the devices (e.g., the printer which has embedded security) utilizes a private key and public Diffie-Hellman parameters to generate a public key of the device. When the other device (e.g., the PC) wants to establish a communication session, the printer exchanges the public key with the other device. The other device (PC) utilizes its own private key and the Diffie-Hellman parameters to generate its public key and exchanges its public key with the printer. Once the public keys and the public values are exchanged, the two entities derive a common shared secret. Once the shared secret is derived by both devices, it is utilized by the devices as a symmetric key, enabling the devices to communicate privately. Alternatively, the devices may employ various techniques to further derive one or more temporary keys from the shared secret, enabling the devices to communicate privately.

With the Diffie-Hellman method, the algorithm requires the use of a prime number large enough to make the strength of protection high. However, in order to obtain such a high level of protection, the key generation process for the embedded device would be very expensive. In addition, many devices such as printers have a lower computing capacity and as a result, the key generation process is very slow. Thus, there is a performance versus security tradeoff, where using fewer bits would result in lower security, and using more bits, performance is compromised.

The foregoing performance versus security tradeoff becomes more of an issue when a secret key needs to be generated for each communication session. That is, in the Diffie-Hellman method, the secret (session) key is usually destroyed once the communication session terminates. U.S. Patent Publication No. 2006/0005026 is one example in which the session key is discarded (i.e., destroyed) once the communication session ends. Thus, if a new secret key needs to be established at the beginning of each communication session, the performance versus security tradeoff comes into play each time a session is commenced.

What is needed, therefore, is a way to provide security, while at the same time increasing performance by reducing the cost of generating a new secret key for each session.

### SUMMARY OF THE INVENTION

The present invention addresses the foregoing problems by providing for long term establishment of the secret key. According to the invention, a second device (e.g., a personal computer) requests to establish a secure communication with a first device (e.g., a printer). In response to the request, the printer generates a first secret key to be utilized for communication sessions with the personal computer. Any one of various algorithms for generating the secret key can be implemented, although a preferred embodiment generates a symmetric key utilizing a Diffie-Hellman algorithm. In the Diffie-Hellman embodiment, values are passed from the printer to the personal computer for generating the secret key. After the secret key is generated by the printer, the secret key is stored in a non-volatile memory (e.g., RAM or Hard Disk Drive or “HDD”) of the printer. When the secret key is stored in the printer, it is stored in association with an identifier of the personal computer. Likewise, the personal computer generates a second secret key corresponding to the first secret key of the printer. After the secret key is generated by the personal computer, it is stored in a non-volatile memory (e.g., RAM or Hard Disk Drive or “HDD”) of the personal computer. When the secret key is stored in the personal computer, it is stored in association with an identifier of the printer. The personal computer then establishes a secure communication session with the printer utilizing the secret key. Alternatively, both devices may derive one or more temporary keys from the secret key, and the temporary keys may be used to establish a secure communication session with the printer.

In the invention, the storage of the generated secret key is intended for long term storage. That is, once the secure communication session is terminated, the key remains stored in the non-volatile memory. Additional state information may also be stored in the non-volatile memory to facilitate the establishment of a new session in the future. The key may even remain stored in the non-volatile memory if the personal computer is powered-off. Thus, when the personal computer wants to establish another communication session with the same printer, it utilizes the stored secret key to establish the secure session. In this manner, the secret key does not have to be re-generated each time a secure communication session is to occur. As a result, a strong key can be generated the first time a secure communication session occurs, thereby resulting in slower connection process the first time, but a faster connection can be made for each subsequent communication session since the secret key is readily available from the storage unit.

This brief summary has been provided so that the nature of the invention may be understood quickly. A more complete understanding of the invention can be obtained by reference to the following detailed description of the preferred embodiments thereof in connection with the attached drawings.

### BRIEF DESCRIPTION OF THE DRAWINGS

FIG. 1 is an overall system view of a networked computing environment in which the present invention may be implemented.

FIG. 2 is a block diagram showing an overview of the internal architecture of a desktop computer.

FIG. 3 is a block diagram showing an overview of the internal architecture of a printer.

FIG. 4 is a block diagram showing an overview of the internal architecture of a server.

FIG. 5 is a block diagram showing a Diffie-Hellman secret key generation process.

FIG. 6 is a flowchart of process steps for the long term establishment of a secret key according to the invention.

FIG. 7 is a diagram depicting the flow of communications between devices according to the invention.

### DETAILED DESCRIPTION OF THE PREFERRED EMBODIMENTS

The following description will be made with regard to a secure printing system in which print jobs are processed by a printer using a public/private keypair of the printer and a secret key. Thus, while the focus of the following description will be made with regard to a secure printing system, the invention is not limited to such and can be employed in other environments where encryption keys and/or secret keys are generated and utilized for secure communications. Specifically, the invention may be employed in a system in which a secure communication is established between one personal computer (PC) and another PC, between a PC and a server, between two different servers, between a PC and a printer, between a server and a printer, etc., so long as the communication involves a secure communication session according to the invention.

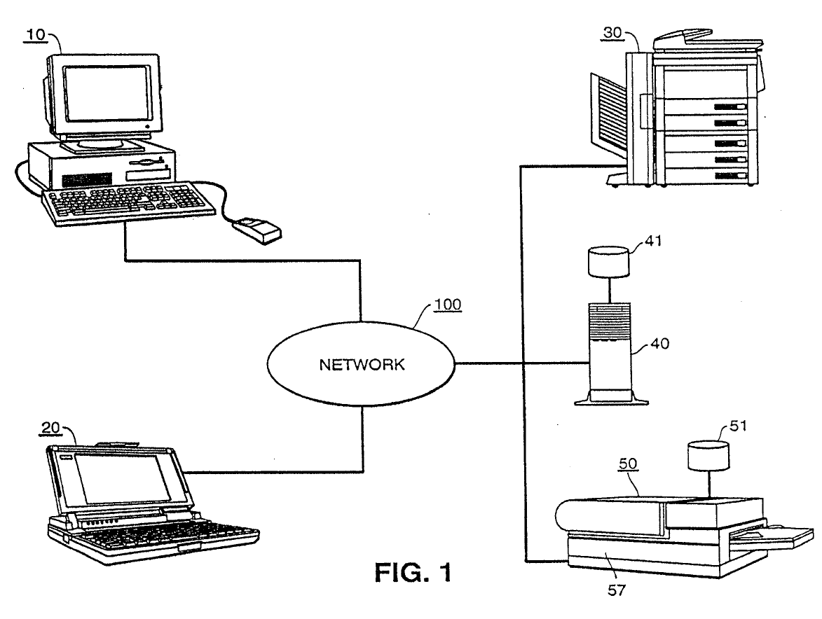

FIG. 1 provides an overall system view of a networked computing environment in which the present invention may be implemented. As shown in FIG. 1, the networked computing environment comprises a network 100 which is connected to desktop computer 10, laptop computer 20, server 40, digital copier 30 and printer 50. Network 100 is preferably an Ethernet-type network medium, although the invention can be utilized over other types of networks, including the internet.

Desktop computer 10 is preferably an IBM PC-compatible computer having a windowing environment such as Microsoft® Windows 2000, Windows XP, Windows NT, or Windows Vista. As is typical with IBM PC-compatible computers, desktop computer 10 preferably has a display, a keyboard, a mouse, and a floppy drive or CD-ROM drive and/or other type of storage medium (not shown). As will be described in more detail below, desktop computer 10 also includes a fixed disk storage medium for storing program codes for executing various functions of the invention.

Laptop computer 20 is also an IBM PC-compatible computer having a windows operating system. Like desktop computer 10, laptop computer 20 also has a display, keyboard, mouse and floppy drive or other storage means (not shown). Also attached to network 100 are digital copier 30 and printer 50, which are capable of receiving image data over network 100 for printing. Digital copier 30 may be, for example, a Canon ImageRunner digital copier, while printer 50 is preferably a laser or bubble-jet printer which is capable of operating as both a printer and a facsimile device. In addition, server 40 is connected to network 100 and comprises an IBM PC-compatible computer having a server operating system such as Windows NT, UNIX or other operating system. Server 40 has a storage device 41 which is preferably a large fixed disk for storing numerous files, whereby server 40 may be utilized by other devices on network 100 as a file server and may also act as a gateway for other devices on network 100 to another network such as the Internet.

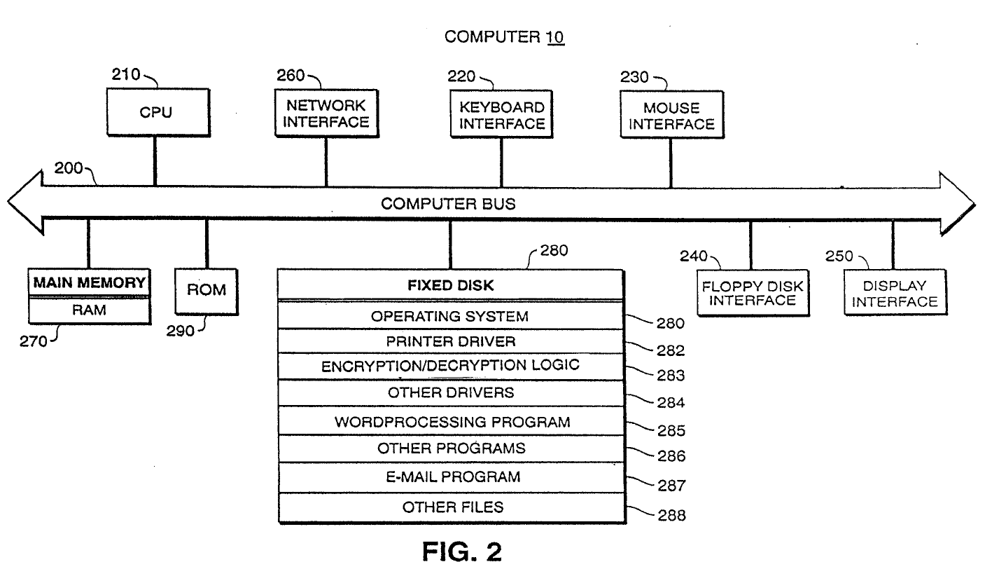

FIG. 2 is a block diagram showing an overview of the internal architecture of desktop computer 10, or alternatively, laptop computer 20. In FIG. 2, desktop computer 10 is seen to include central processing unit (CPU) 210 such as a programmable microprocessor which is interfaced to computer bus 200. Also coupled to computer bus 200 are keyboard interface 220 for interfacing to a keyboard, mouse interface 230 for interfacing to a pointing device, floppy disk interface 240 for interfacing to a floppy disk or CD-ROM, display interface 250 for interfacing to a display, and network interface 260 for interfacing to network 100.

Random access memory (“RAM”) 270 interfaces to computer bus 200 to provide central processing unit (“CPU”) 210 with access to memory storage, thereby acting as the main run-time memory for CPU 210. In particular, when executing stored program instruction sequences, CPU 210 loads those instruction sequences from fixed disk 280 (or other memory media) into random access memory (“RAM”) 270 and executes those stored program instruction sequences out of RAM 270. It should also be noted that standard-disk swapping techniques available under windowing operating systems allow segments of memory to be swapped to and from RAM 270 and fixed disk 280. Read-only memory (“ROM”) 290 stores invariant instruction sequences, such as start-up instruction sequences for CPU 210 or basic input/output operation system (“BIOS”) sequences for the operation of peripheral devices attached to computer 10.

Electrically Erasable Programmable Read-Only Memory (EEPROM) 265 is a non-volatile storage chip for storing small amounts of volatile data (e.g., calibration tables or device configuration information). EEPROM 265 may also be utilized for long term storage of a secret key in accordance with the invention.

Fixed disk 280 is one example of a computer-readable medium that stores program instruction sequences executable by central processing unit (“CPU”) 210 so as to constitute operating system 281, printer driver 282, encryption/decryption logic 283, other drivers 284, word processing program 285, other programs 286, e-mail program 287 and other files 288. As mentioned above, operating system 281 is preferably a windowing operating system, although other types of operating systems (e.g., MAC) may be used instead. Printer driver 282 is utilized to prepare image data for printing on at least one image forming device, such as printer 50 or digital copier 30. Encryption/decryption logic 283 is utilized to perform various security related functions involving the generation and storage of encryption keys (e.g., public/private key pairs, secret keys, etc.). Other drivers 284 include drivers for each of the remaining interfaces which are coupled to computer bus 200.

Word processing program 285 is a typical word processor program for creating documents and images, such as Microsoft Word, or Corel WordPerfect. Other programs 286 contains other programs necessary to operate desktop computer 10 and to run desired applications. E-mail program 287 is a typical e-mail program that allows desktop computer 10 to receive and send e-mails over network 100. Other files 288 include any of the files necessary for the operation of desktop computer 10 or files created and/or maintained by other application programs on desktop computer 10. Fixed disk 280 is another memory medium type that may also be used for long term storage of a secret key in accordance with the invention.

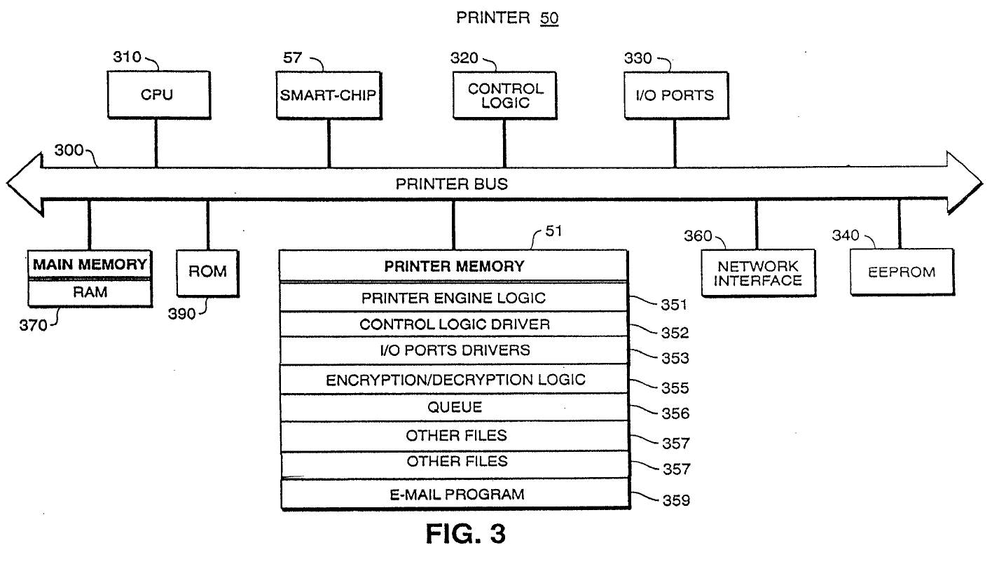

FIG. 3 is a block diagram showing an overview of the internal architecture of printer 50. In FIG. 3, printer 50 is seen to contain a central processing unit (“CPU”) 310 such as a programmable microprocessor which is interfaced to printer bus 300. Also coupled to printer bus 300 are control logic 320, which is utilized to control the printer engine of printer 50 (not shown), I/O ports 330 which is used to communicate with various input/output devices of printer 50 (not shown), and network interface 360 which is utilized to interface printer 50 to network 100.

Also coupled to printer bus 300 are EEPROM 340, for containing non-volatile program instructions, random access memory (“RAM”) 370, printer memory 51 and read-only memory (“ROM”) 390. RAM 370 interfaces to printer bus 300 to provide CPU 310 with access to memory storage, thereby acting as the main run-time memory for CPU 310. In particular, when executing stored program instruction sequences, CPU 310 loads those instruction sequences from printer memory 51 (or other memory media) into RAM 370 and executes those stored program instruction sequences out of RAM 370. ROM 390 stores invariant instruction sequences, such as start-up instruction sequences for CPU 310 or BIOS sequences for the operation of various peripheral devices of printer 50 (not shown).

Printer memory 51 is one example of a computer-readable medium that stores program instruction sequences executable by CPU 310 so as to constitute printer engine logic 351, control logic driver 352, I/O port drivers 353, encryption/decryption logic 355, queue 356, other files 357, and e-mail program 359. Printer engine logic 351 and control logic driver 352 are utilized to control and drive the printer engine of printer 50 (not shown) so as to print an image according to image data received by printer 50, preferably over network 100. I/O port drivers 353 are utilized to drive the input and output devices (not shown) connected through I/O ports 330.

Encryption/decryption logic 355 enables printer 50 to receive encrypted data according to the present invention and to carry out the necessary steps to enable the decryption of the encrypted print data. Specifically, encryption/decryption logic 355 may be any of various types of security related programs for generating security credentials of the printer. For example, encryption/decryption logic 355 may utilize a Diffie-Hellman algorithm to generate a public/private keypair for the printer, as well as a secret key, and the secret key may be stored in printer memory 51 as a persistent storage medium. The details of these steps are discussed more fully below.

Queue 356 is utilized to contain a print queue comprised of numerous print jobs which are to be printed. Other files 357 contain other files and/or programs for the operation of printer 50. Lastly, e-mail program 359 is a typical e-mail program for enabling printer 50 to receive e-mail messages from network 100.

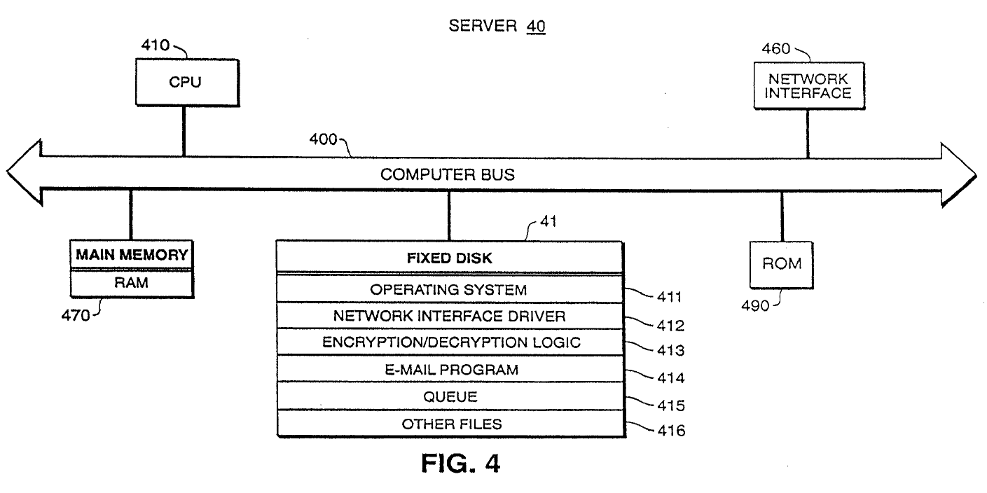

FIG. 4 is a block diagram showing an overview of the internal architecture of server 40. In FIG. 4, server 40 is seen to include a central processing unit (“CPU”) 410 such as a programmable microprocessor which is interfaced to computer bus 400. Also coupled to computer bus 400 is a network interface 460 for interfacing to network 100. In addition, random access memory (“RAM”) 470, fixed disk 41, and read-only (“ROM”) 490 are also coupled to computer bus 400. RAM 470 interfaces to computer bus 400 to provide CPU 410 with access to memory storage, thereby acting as the main run-time memory for CPU 410. In particular, when executing stored program instruction sequences, CPU 410 loads those instruction sequences from fixed disk 41 (or other memory media) into RAM 470 and executes those stored program instruction sequences out of RAM 470. It should also be recognized that standard disk-swapping techniques allow segments of memory to be swapped to and from RAM 470 and fixed disk 41. ROM 490 stores invariant instruction sequences, such as start-up instruction sequences for CPU 410 or basic input/output operating system (“BIOS”) sequences for the operation of peripheral devices which may be attached to server 40 (not shown).

Fixed disk 41 is one example of a computer-readable medium that stores program instruction sequences executable by CPU 410 so as to constitute operating system 411, network interface driver 412, encryption/decryption logic 413, e-mail program 414, queue 415, and other files 416. As mentioned above, operating system 411 can be an operating system such as Windows NT, UNIX, or other such operating system. Network interface driver 412 is utilized to drive network interface 460 for interfacing server 40 to network 100. Encryption/decryption logic 413 allows server 40 to receive encrypted data and to either maintain such data in queue 415 or to send such data to an image forming device such as printer 50 for printing. Encryption/decryption logic 413 is generally only required where a secure transmission protocol or a key establishment protocol is used between the server and the printer or other devices. Encryption/decryption logic 413 is similar to encryption/decryption logic 283 of computer 10. E-mail program 414 is a typical e-mail program and enables server 40 to receive and/or send e-mail messages over network 100. Queue 415 is utilized to store numerous print jobs for output on one or more image forming devices, such as printer 50. Lastly, other files 416 contains other files or programs necessary to operate server 40 and/or to provide additional functionality to server 40.

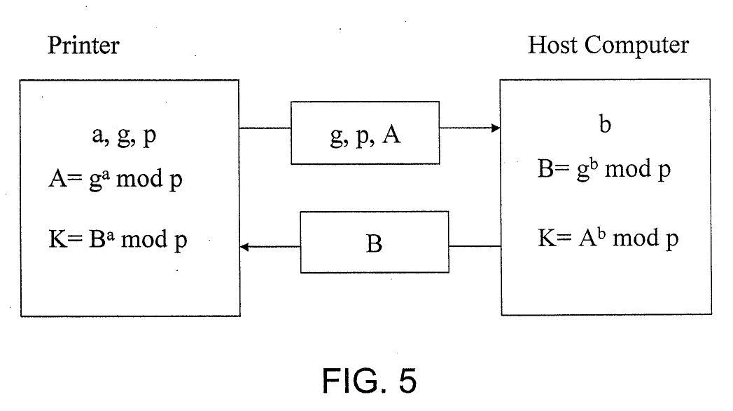

In the context of the network environment shown in FIG. 1, the operation of the present invention will now be described with regard to FIGS. 5 to 7. Briefly, FIGS. 5 to 7 depict a process for conducting a secure communications session between two devices utilizing a secret key for the communication. In one embodiment described below, a Diffie-Hellman process is used to generate the secret keys in each device. Once the secret keys are generated, however, they are stored in a persistent storage medium in the respective device. The stored keys may be used directly or may be further utilized to generate temporary keys for use during the current communication, and after the current session has been terminated, the secret key stored in the persistent storage medium is retrieved for later (i.e., future) communication sessions between the same client and device rather than generating a new secret key for each later communication session. In this manner, efficiency of the communication session is increased by reducing the time required to generate a new secret key each time, but the security level is retained since the originally generated secret key is generated with a high degree of security.

Referring now to FIG. 5, a typical Diffie-Hellman secret key generation process is depicted therein. In FIG. 5, the following variables apply.
a=Private key (private value) of the device (printer)
A=Public key (public value) of the device (printer)
b=Private key (secret value) of the client (host)
B=Public key (public value) of the client (host)
p=prime number (public value)
g=generator (an integer less than p) (public value)
K=secret key

In the Diffie-Hellman process, when the device (e.g., a printer) starts up, it generates its own random private key a and accesses public values, p and g. The device then derives its own public key A utilizing the algorithm A=g^{a} mod p. When the device receives a request for a secure communication session from a client (e.g., a host computer (PC)), it responds by transmitting the public values p and g and the generated public key A of the device to the client. The client generates its own private key b, and utilizing the public values p and g provided by the device, generates its public key B utilizing the algorithm B=g^{b} mod p. The client then provides its public value key B to the device (printer), and proceeds to generate a secret key K for the communication session between the client and the device. The client generates the secret key K utilizing the public key A of the device (printer) and its own private key b via the algorithm K=A^{b} mod p. The device (printer), upon receiving the public key B of the client, likewise generates the secret K, but utilizes the public key B of the client and its own private key a via the algorithm K=B^{a} mod p. As is known in the art, each secret key K generated by the respective devices is the same since K=A^{b} mod p=(g^{a} mod p)^{b} mod p=g^{ab} mod p=(g^{b} mod p)^{a} mod p=B^{a} mod p. The secret keys are then used for the secure communication session between the devices. However, as will be explained in more detail below, the secret keys, rather than being discarded upon termination of the communication session, thereby having to be regenerated at commencement of a new communication session, are stored in a persistent storage medium for use in future secure communication sessions.

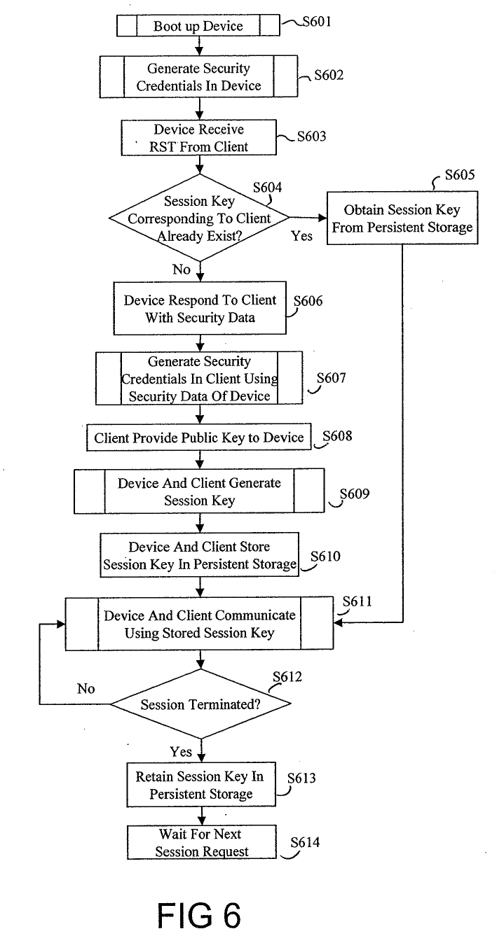

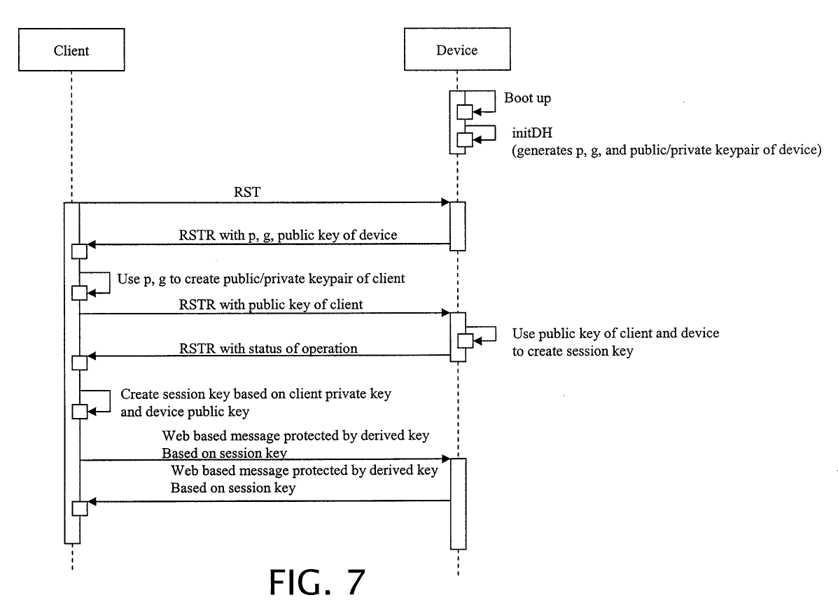

FIG. 6 is a flowchart of process steps for the long term establishment of a secret key according to the invention. FIG. 7 is a diagram showing the flow of communication between devices corresponding to some of the steps of FIG. 6. As seen in FIG. 6, when the device (e.g., printer 50) is turned on, it boots up (step S601). Once the printer boots up, in step S602, the printer's encryption/decryption logic 355 may generate the security credentials for the printer. For example, the printer's encryption/decryption logic, if employing Diffie-Hellman security protocol, may access the public values p and g, and may also generate a private key (e.g., a random number). Then, utilizing p, g and a, the printer may generate its public key A. As an alternative to generating the security credentials upon start up, the printer may wait until receiving a request for a secure communication session from a client before initiating generation of the security credentials.

When a secure communication session is to be initiated, a client (e.g., host computer 10) transmits a request for the secure communication session (RST) to the printer. When the printer receives the RST request (step S603), the printer determines whether or not a secret key for the client already exists (step S604). This step is in contrast to a conventional Diffie-Hellman communication session in which the secret keys are discarded upon termination of the communication session and therefore, need to be regenerated. In the invention, once the secret keys for the printer and a particular client have been generated, they are stored in persistent storage so that, when a new communication session is commenced, the secret key can be retrieved and used for the session without having to regenerate the key. Thus, if the printer determines that the secret key for the particular client transmitting the RST request is already present, the printer obtains the key from the persistent storage (step S605) and the communication session is conducted using the stored key (step S611).

If, however, step S604 determines that the secret key does not already exist (e.g., this is the first time that this particular client has requested a secure communication session with the printer, or the secret key was erased from the persistent storage for some reason), then the printer responds to the RST request and provides the client with the security data of the printer (step S606). In the Diffie-Hellman embodiment, the printer responds to the client request by providing the public values p and g generated by the printer, as well as the printer's public key A.

Utilizing the security data provided in step S606, the client generates its own security credentials (step S607). In the Diffie-Hellman embodiment, the encryption/decryption logic in the client (e.g., encryption/decryption logic 283 in host computer 10) generates its own private key b, and generates its public key B utilizing the algorithm B=g^{b} mod p. After generating its own security credentials, the client provides its public key B to the printer. Additionally, the encryption/decryption logic 283 of the client utilizes its private key and the public key of the printer, along with the public value p to generate the secret key K via the algorithm K=A^{b} mod p (step S609). The encryption/decryption logic 355 of printer 50 likewise generates the secret key K utilizing its private key a and the public key B of the client via the algorithm K=B^{a} mod p (step S609). It should be noted that, while step S609 depicts a single step wherein both the client and the printer generate their respective secret key, it is not necessarily the case that both devices simultaneously generate their respective keys and the depiction of a single step in FIG. 6 is merely for simplicity of the description.

Once the client generates its respective secret key, it stores it in a non-volatile storage medium for long term storage (step S610). The device likewise stores its respective secret key in a non-volatile storage medium for long term storage (step S610). The non-volatile storage medium in which the secret key may be stored may be EEPROM, Flash memory, hard disk drive, etc. When the key is stored in the non-volatile storage medium, it is preferably stored in association with identification information of the corresponding communication partner. That is, the secret key stored in the client is stored in conjunction with information identifying the printer, and the secret key stored in the printer is stored in conjunction with information identifying the client. The secret keys may also be stored in conjunction with state information. For example, the state information may include information identifying previous communication sessions, previously-used session keys, etc. Such related state information is preferably stored in a non-volatile memory of printer and the client, but need not be stored in the same memory as the stored secret key.

After the secret keys are generated and stored, they are then used for the communication session between the client and the printer (step S611). Alternatively, one or more session keys may be further derived from the secret key and the session key(s) may be used for the communication session between the client and the printer. So long as the current communication session continues (NO in step S612), the client and the device utilize the secret keys to communicate. If, however, the current communication session ends (YES in step S612), the secret keys are retained in the non-volatile storage medium of each respective device (step S613), and the devices wait for a new session request (step S614).

Since the printer has generated its security credentials upon initial startup (i.e., generated its public/private keypair), a new communication session request from a client would begin processing at step S603. When a new communication session request is received, the printer determines whether or not a secret key already exists for the client requesting the new session (step S604). If the request is from the same client that engaged in the previous session with the printer, the printer would determine that the secret key exists since it has been stored in a non-volatile storage medium of the printer, so long as the key has not been erased for some reason. One reason the secret key may be erased is due to a power-off or power failure of the printer. In this case, the printer would generate new credentials upon startup after the power-off and a new secret key would be generated for the corresponding client. Of course, the secret key may be retained in the non-volatile storage medium despite a power off and in this case, the printer would determine that the secret key exists for the same client. If the request is from a new client that the printer has not previously communicated with, then of course, a new secret key corresponding to the new client would be generated utilizing the steps of FIG. 6.

While the foregoing description has been made with regard to a host computer as the client and a printer as the device, it can readily be understood that the client may be virtually any type of device (e.g., server, mobile terminal, etc.) and the device may be any type of device besides a printer (e.g., PC, server, digital copier, mobile terminal, etc.) It should also be understood that, while the foregoing description has been made with regard to employing a Diffie-Hellman process for generating the secret key, other types of processes may be used instead.

It can also be understood that the invention may be embodied as computer-executable code stored on a computer-readable storage medium, including but not limited to compact disk, floppy disk, magnetic tape, hard disk drive, etc. The computer code may be process steps written to execute the processes described herein.

While the invention has been described with particular illustrative embodiments as discussed above, it is to be understood that the invention is not limited to the above-described embodiments and that various changes and modifications may be made by those of ordinary skill in the art without departing from the spirit and scope of the invention.

What is claimed is:

1. A method for establishing a secure communication session between a first device and a second device, the method comprising:
generating, in the first device, a first secret key to be utilized for communication sessions with other devices;
the second device requesting to establish a first communication session with the first device;
the second device generating a second secret key corresponding to the first secret key of the first device;
the second device storing the generated second secret key in a non-volatile memory of the second device, the second secret key being stored in the non-volatile memory in association with an identifier of the first device; and
establishing a secure communication session between the first and second devices utilizing the first and second secret keys.

2. The method according to claim 1, further comprising the second device establishing a second secure communication session, after termination of the first communication session, utilizing the second secret key stored in the non-volatile memory of the second device.

3. The method according to claim 1, wherein the secret key is a symmetric key.

4. The method according to claim 1, wherein the first and second secret keys are generated using a Diffie-Hellman algorithm.

5. The method according to claim 1, further comprising storing the first secret key in a non-volatile memory of the first device, wherein the first and second secret keys remain stored in the non-volatile memory of each respective device after the first communication session has been terminated, and the stored keys are utilized for further communication sessions between the first and second devices.

6. The method according to claim 1, wherein, in a case of a power-off of the second device, the second secret key remains stored in the non-volatile memory of the second device despite the power-off.

7. The method according to claim 1, wherein state information is stored in the non-volatile memory in association with the secret key.

8. An apparatus that establishes a secure communication session with another device utilizing a secret key for the communication, comprising:
a communication unit that requests to establish a secure communication session with the other device;
a secret key generating unit that generates a secret key for the secure communication session with the other device, wherein the generated secret key corresponds to a secret key of the other device; and
a non-volatile storage unit that stores the generated secret key, wherein the generated secret key is stored in the non-volatile storage unit in association with an identifier of the other device,
wherein the communication unit further establishes a secure communication session with the other device utilizing the generated secret key.

9. The apparatus according to claim 8, wherein the communication unit further establishes a second secure communication session, after termination of the first communication session, utilizing the secret key stored in the non-volatile storage unit.

10. The apparatus according to claim 8, wherein the secret key is a symmetric key.

11. The apparatus according to claim 8, wherein the generating unit generates the secret key using a Diffie-Hellman algorithm.

12. The apparatus according to claim 8, wherein the generated secret key remains stored in the non-volatile storage unit after the communication session has been terminated, and the stored key is utilized for further communication sessions between the apparatus and the other device.

13. The apparatus according to claim 8, wherein, in a case of a power-off of the apparatus, the generated secret key remains stored in the non-volatile storage unit of the apparatus despite the power-off.

14. The apparatus according to claim 8, wherein state information is stored in the non-volatile memory in association with the secret key.

15. A computer readable storage medium on which is stored a computer executable program that, when executed by a computing system, implements a method for establishing a secure communication session between a first device and a second device, the method comprising:
generating, in the first device, a first secret key to be utilized for communication sessions with other devices;
the second device requesting to establish a first communication session with the first device;
the second device generating a second secret key corresponding to the first secret key of the first device;
the second device storing the generated second secret key in a non-volatile memory of the second device, the second secret key being stored in the non-volatile memory in association with an identifier of the first device; and
establishing a secure communication session between the first and second devices utilizing the first and second secret keys.
